(19) United States
(12) Patent Application Publication
(10) Pub. No.: US 2011/0127296 A1
(43) Pub. Date: Jun. 2, 2011

(54) APPARATUS FOR SIMULTANEOUSLY DISPENSING TWO PRODUCTS

(76) Inventors: Jeffrey Marc Hayet, Wayne, NJ (US); James C. Wightman, Livingston, NJ (US)

(21) Appl. No.: 12/627,582

(22) Filed: Nov. 30, 2009

(51) Int. Cl. B67D 7/74

(52) U.S. Cl. 222/145.1

(57) ABSTRACT

A product dispensing unit is provided configured to house two products in separate tubes, wherein the two products may be simultaneously dispensed from the product dispensing unit. According to an embodiment of the present invention, the product dispensing unit comprises an outer channel configured to facilitate the flow of the first product flows from an outer tube cavity to a dispensing site and an inner channel configured to facilitate the flow of a second product from an inner tube cavity to dispensing site. Application of pressure to the product dispensing unit may results in simultaneously dispensing the first product and the second product from the product dispensing unit.

### FIELD OF THE INVENTION

The present invention relates to an apparatus for dispensing products, more particularly, to an apparatus configured to house two products, wherein the products remain separated while housed in the apparatus, and may be simultaneously dispensed from the apparatus.

### BACKGROUND OF THE INVENTION

Product dispensing units are known in the art to allow for housing and dispensing of fluid products. As used herein, the term “product” is intended to include, but is not limited to, any fluid substance or material capable of flowing, including for example, gels, creams, cosmetics, therapeutic remedies, medicines, and food items. Most product dispensing units provide a reservoir for housing a single product and an outlet where the product is dispensed. A user may apply pressure to an external portion of the product dispensing unit to dispense the contained product from the unit.

In addition to product dispensing units configured to house and dispense a single product, alternative conventional product dispensing units may provide for the storing and dispensing of two products. According to such a design, each product may be stored in an individual tube, wherein the two products remain separate from one another until the products are dispensed from the product dispensing unit. In some traditional multi-product units, the individual tubes are oriented in a side-by-side alignment, wherein the tubes share a common outer barrier surface. Alternatively, an outer tube may surround an inner tube, creating a product dispensing unit wherein the inner tube is nested within the outer tube.

However, conventional product dispensing units having a nested arrangement fail to provide a secure fit between the inner tube and the outer tube. Without a secure fit between the two tubes, there is a high likelihood that the inner tube will decouple from the outer tube, thereby interrupting the flow of the products through the product dispensing unit. In addition, insufficiently securing an inner to with an outer tube may result in seepage of products between tubes and issues confronted when filling and sealing the product dispensing unit.

One example of a conventional product dispensing unit configured to house two products which suffers from the aforementioned problems is described U.S. Patent Application Publication No. 2007/0267436 (herein “Abbot”). Abbot describes a product dispensing unit wherein the inner tube is secured to the outer tube through the use of four small ribs located at spaced apart intervals on the nozzle of the inner tube. The ribs provide the only means of engagement and as a result the inner tube lacks sufficient engagement with the outer tube. As with other conventional product dispensing units, these small ribs provide an insufficient means of securing the inner tube to the outer tube.

Efforts have been made to further secure an inner tube to an outer tube in certain conventional product dispensing units by increasing the size or number of securing ribs. However, these attempts have resulted in restricting the flow of the products within and from the product dispensing unit. In such designs, the additional means used to secure the inner tube to the outer tube undesirably creates a barrier which impedes the flow of the product and disrupts the way in which the products are dispensed from the unit. For example, in such a design, the securing means restricts the ability of the product in the outer tube to surround the product in the inner tube when the two products are dispensed for the product dispensing unit.

The prior art multi-product dispersing units fail to provide a secure fit between an inner tube and an outer tube while still allowing for control over the flow of the products as they are dispensed from the product dispensing unit.

### SUMMARY OF THE INVENTION

Embodiments of the present invention satisfy these needs and other needs by providing a product dispensing unit that secures an inner tube, housing a first product, with an outer tube, housing a second product, in a nested configuration while providing for control over the orientation of the first and second products as they are dispensing from the product dispensing unit.

According to an embodiment of the present invention, the product dispensing unit is configured to house two products in separate tubes, wherein the two products can be simultaneously dispensed from the product dispensing unit. In such an embodiment, the product dispensing unit comprises an outer tube configured to surround the inner tube. Each tube includes a cavity to house a product. The products in the cavities remain separate from on another while housed in the product dispensing unit.

For example, the outer tube cavity may house a hair dye product and the inner tube cavity may house an activator used in conjunction with the hair dye. In such an example, the hair dye and the activator must not come into contact with each other until just prior to use. As such, the a product dispensing unit allows for both product to remain separate from one another while respectively housed in the inner tube cavity and outer tube cavity, mixing only when they are dispensed from the product dispensing unit.

Embodiments of the present invention comprise an inner channel and an outer channel to facilitating the movement of the products within the product dispensing unit and allows for both products to be dispensed from the product dispensing unit at a dispensing site on the nozzle of the outer tube. According to an embodiment of the present invention, the outer channel provides for fluid communication between the outer tube cavity and the dispensing site of the nozzle of the outer tube. The inner channel provides for fluid communication between the inner tube cavity and the dispensing site of the nozzle of the outer tube. As a result, the product in the outer tube may flow through the outer channel and the product in the inner tube may flow through the inner channel. Both products are dispensed from the product dispensing unit at the nozzle of the outer tube.

The inner tube is primarily secured to the outer tube by way of an interaction between the nozzle of the outer tube and the inner tube first end. According to an embodiment of the present invention, the inner tube first end includes an engagement member and a dispensing point. The engagement member may provide the interaction to secure the inner tube to the outer tube. The engagement member may be a circular portion of the inner, tube first end that creates a secure frictional interaction with the nozzle of the outer tube. The interaction between the nozzle and the engagement member may a frictional interaction or any other interaction capable of securing the engagement member to the nozzle. In addition, the engagement member may comprise one or more ports to allow the outer channel to come into fluid communication with the outer tube cavity. As a result, the engagement member provides for a secure connection between the inner tube and outer tube while still providing a channel to facilitate the flow of product from outer tube cavity.

In addition, the engagement member may surround a dispensing point located on the inner tube first end and may define the inner channel. The inner channel is in fluid communication with the inner tube cavity and facilitates dispensing of the product housed in the inner tube. The circular configuration of the engagement member around the dispensing conduit results in creating an outer channel that surrounds the inner channel. Given that the outer channel surrounds the inner channel, application of pressure to the body on the product dispersing unit will result in simultaneously dispensing the product from the inner tube cavity and the product from the outer tube wherein the product from the outer tube may surround the product from the inner tube, when dispensed.

Embodiments of the present invention may be used to house products that required specific material to effectively store one or both on the products. Certain products may erode traditional plastic housings and result in seepage between the contents of the inner tube and the contents of the outer tube. As such, a variety of materials may be used to construct the inner tube or outer tube. In certain embodiments the tubes may be constructed of the same material, while in alternative embodiments the inner tube and outer tube may not be constructed from the same material.

### BRIEF DESCRIPTION OF THE DRAWINGS

The present invention will be more readily understood from the detailed description of exemplary embodiments presented below considered in conjunction with the attached drawings, of which:

FIG. 1 illustrates a perspective view of an exemplary product dispensing unit, according to an embodiment of the present invention;

FIG. 2A illustrates a first perspective view of an inner tube of an exemplary product dispensing unit, according to an embodiment of the present invention;

FIG. 2B illustrates a second perspective view of an inner tube of an exemplary product dispensing unit, according to an embodiment of the present invention; and

FIG. 3 illustrates a perspective cross-sectional view of an exemplary product dispensing unit, according to an embodiment of the present invention.

### DETAILED DESCRIPTION OF THE INVENTION

The present invention relates to a product dispensing unit configured to separately house two products and simultaneously dispense both products in response to the application of pressure to the product dispensing unit. The product dispensing unit comprises an outer tube substantially surrounding an inner tube. The outer tube is configured to house a first product and the inner tube is configured to house a second product.

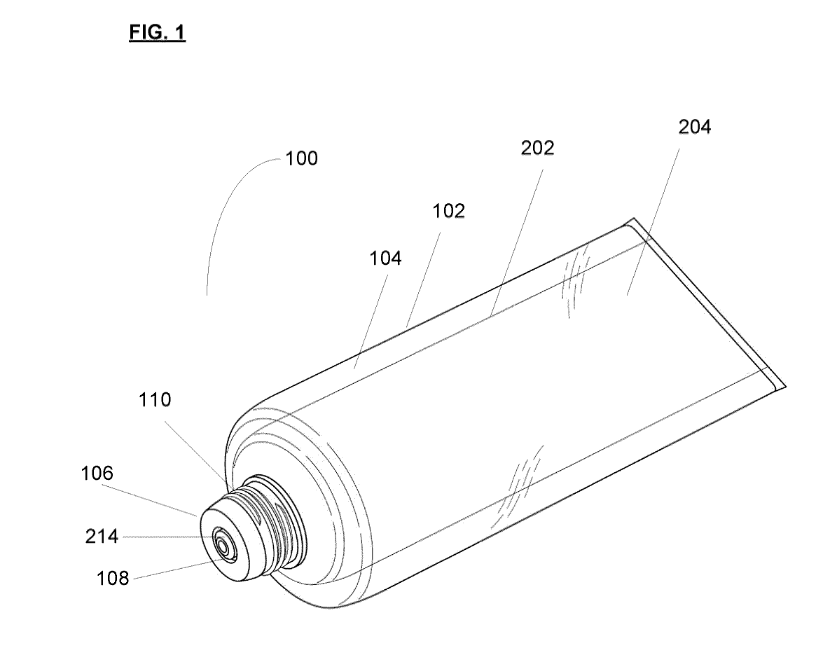

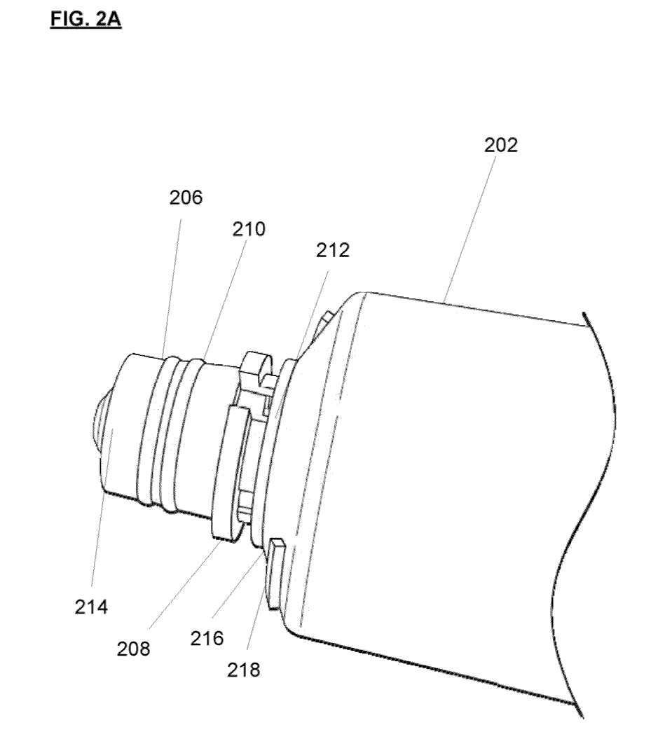

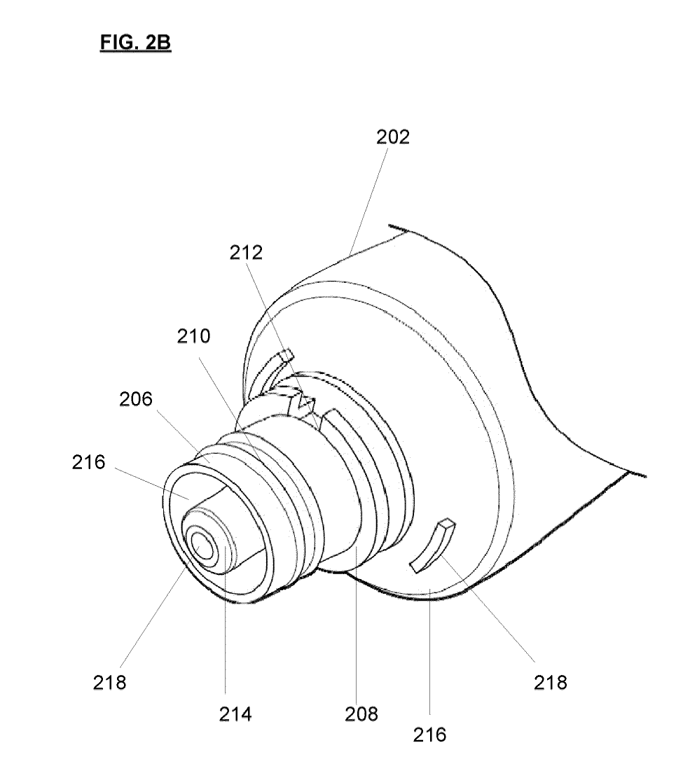

FIG. 1 depicts an exemplary product dispensing unit 100 according to an embodiment of the present invention. Product dispensing unit 100 comprises an outer tube 102 and an inner tube 202. The outer tube 102 comprises an outer tube cavity 104 configured to substantially surround the inner tube 202 as well as house a first product (not shown). The inner tube 202 is secured to the outer tube 102 and comprises an inner tube cavity 204. The inner tube cavity 204 is configured to house a second product (not shown). Portions of the inner tube 202 are illustrated in greater detail in FIGS. 2A and 2B.

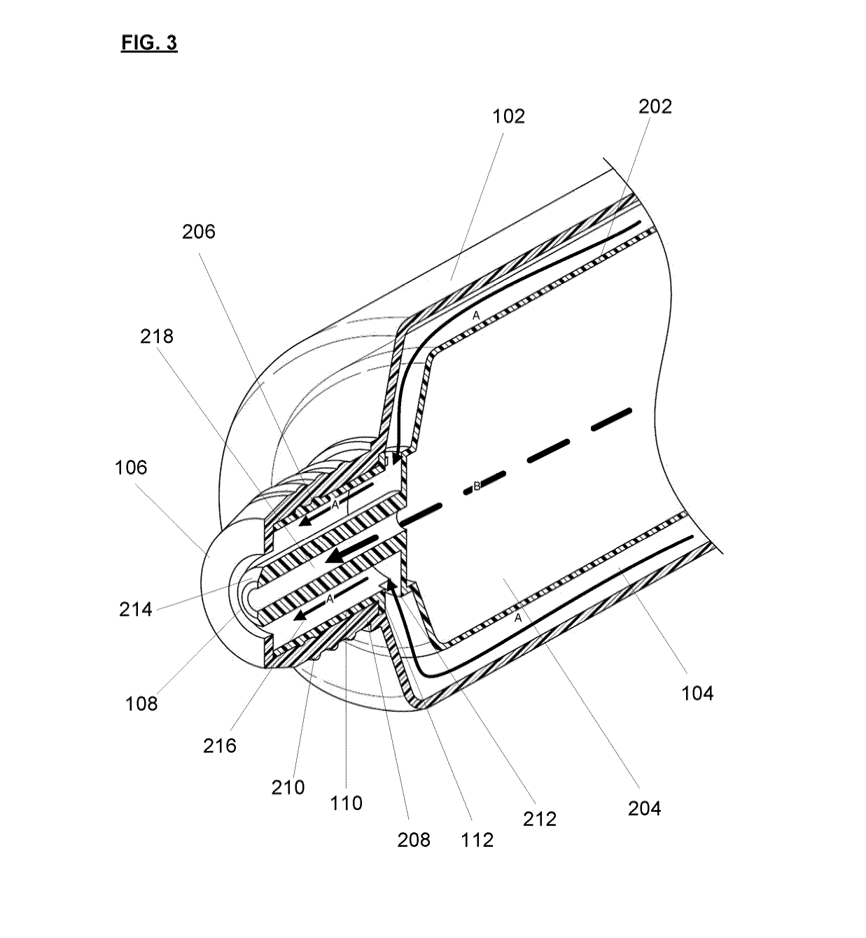

The outer tube 102 comprises a nozzle 106 located at a first end of the product dispensing unit 100. The nozzle 106 includes an area, referred to as dispensing site 108, at which the first product and the second product are dispensed from the product dispensing unit 100. The dispensing site 108 is in fluid communication with an outer channel (shown in FIGS. 2A and 2B) and an inner channel (shown in FIG. 3). According to an embodiment of the present invention, the outer channel 216 is a conduit through which the first product flows from the outer tube cavity 104 to the dispensing site 108, wherein the flow direction of the first product is identified in FIG. 3 by the solid arrow ‘A.’ Furthermore, the inner channel 218 is a conduit through which the second product may flow from the inner tube cavity 204 to dispensing site 108, wherein the flow direction of the second product is identified in FIG. 3 by the dotted arrow ‘B.’ Both the outer channel 216 and the inner channel 218 will be discussed in greater detail below.

According to an embodiment of the present invention, as illustrated in FIG. 1, the nozzle 106 further comprises a thread set 110. The thread set 110, located on an externally facing surface of the nozzle 106 is configured to receive and secure a cap (not shown), wherein the cap is used to minimize or eliminate unintended dispensing of products from the product dispensing unit 100 by capping or covering the dispensing site 108. Alternative embodiments of the present invention may not include the thread set 110 and, as a result, a cap is secured to the product dispensing unit 100 through alternative securing means. In a further embodiment of the present invention, the product dispensing unit 100 may not utilize a cap.

In the embodiment of the present invention illustrated in FIG. 1, the nozzle 110 substantially surrounds a dispensing conduit 214. The dispensing conduit 214 is a portion of the inner tube 202 and is configured to aid in dispensing the second product from the inner tube 202. The dispensing conduit 214 is described in greater detail in regards to FIGS. 2A, 2B and 3.

FIGS. 2A, 2B and 3 illustrate an engagement member 206 of the inner tube 202. The engagement member 206 comprises an engagement shelf 208, one or more engagement ribs 210, one or more ports 212, the dispensing conduit 214, an outer channel 216 and the inner channel 218. According to certain embodiments of the present invention, the inner tube 202 is secured to the outer tube 102 by way of a frictional connection between the engagement member 206 of the inner tube 202 and the nozzle 106 of the outer tube 102. In addition, the engagement member 206 is configured to facilitate the flow of the first product and the second product through the product dispensing unit 100, as discussed in greater detail in regards to FIG. 3.

As illustrated in FIG. 2A, the engagement shelf 208 is a protrusion that at least partially surrounds the engagement member 206. The engagement shelf 208 provides one points at which a frictional connection is created between the engagement member 206 and the nozzle 106. This frictional connection is further described below in regards to FIG. 3. According to the embodiment of the engagement member 206 illustrated in FIGS. A and B, the engagement shelf 208 comprises a break or opening and as a result does not completely surround the engagement member 206. However, in an alternative embodiment of the present invention, the engagement shelf 208 may completely surround the engagement member 206.

In addition to the engagement shelf 208, the inner tube 202 may be further secured to the outer tube 102 through the use of the engagement ribs 210. As illustrated in FIGS. 2A and B, the engagement ribs 210 are concentric protrusions surrounding the engagement member 206. The engagement ribs 210 provide an additional frictional connection between the engagement member 206 and the nozzle 106. This additional frictional connection may aid in securing the inner tube 202 to the outer tube 102. The embodiment of the present invention illustrated in FIGS. 2A and 2B includes two engagement ribs however alternative embodiments of the present invention may not include engagement ribs 210 or may include one or more engagement ribs 210. This frictional connection is further described below with reference to FIG. 3. According to certain embodiments of the present invention, the engagement ribs 210 may also facilitate the creation of a seal between the engagement member 206 and the nozzle 106. The seal may restrict the flow of product along the interface between the engagement member 206 and the nozzle 106.

In addition to the engagement member 206, the inner tube 202 further comprises the dispensing conduit 214. The dispensing conduit 214 facilitates the flow of the second product through the product dispensing unit 100. According to an embodiment of the present invention, the dispensing conduit 214 may be a hollow cylindrical structure wherein the space within the dispensing conduit 214 defines the inner channel 218. As described in greater detail in FIG. 3, the inner channel 218 is in fluid communication with the inner tube cavity 204. As a result of this fluid communication, when pressure is applied to the product dispensing unit 100, the second product, located in the inner tube cavity 204, may flow from the inner tube cavity 204 through the inner channel 218 and be dispensed at the dispensing site 108.

According to the embodiment of the present invention illustrated in FIG. 2A, the engagement member 206 surrounds the dispensing conduit 214. The area between the engagement member 206 and the dispensing conduit 214 forms the outer channel 216. The outer channel is configured to facilitate the flow of the second product through the product dispensing unit 100. The port or ports 212 located on the engagement member 206 provide openings in the engagement member 206 and allow for fluid communication between the outer channel 216 and the outer tube cavity 104. As a result of this fluid communication, when pressure is applied to the product dispensing unit 100 the first product may flow from the outer tube cavity 104 through a port 212 into the outer channel 216 and be dispensed at the dispensing site 108. In the embodiment of the present invention illustrated in FIG. 2B two ports 212 are visible located on the engagement member 206 are clearly visible. According to alternative embodiments of the present invention, one or more ports may be used to create a fluid communication between the outer tube cavity 104 and the outer channel 216. Given the perspective view of FIG. 2A only one port 212 is visible; however, other ports 212 may be located in the space beneath the engagement shelf 208.

According to the embodiment of the inner tube 202 illustrated in FIGS. 2A and 2B, the inner tube 202 includes one or more support structures 218 located on the inner tube neck 216. The support structures 218 may be protrusions from the inner tube neck 216. When the inner tube 202 is engaged with the outer tube 102, the support structures 218 provide contact with the outer tube 102. Contact between the support structures 218 and the inner tube 202 aids in maintaining the inner tube 202 and the outer tube 102 in a concentric orientation during assembly, filling and use of the product dispensing unit. The embodiment of the inner tube 202 illustrated in FIGS. 2A and 2B comprises two support structures 218, however, alternative embodiments of the inner tube may include one or more support structures.

In an alternative embodiment of the present invention, the inner tube may not include a dispensing conduit. According such an embodiment, the inner channel and the outer channel may be defined by a wall segmenting the area within the engagement member. As a result, the inner channel and the outer channel may be oriented in a side-by-side fashion within the engagement member.

FIG. 3 illustrates a perspective cross-sectional view of an embodiment of the product dispensing unit 100. This perspective cross-sectional view of the product dispensing unit 100 illustrates the way in which the inner tube 202 is secured to the outer tube 102 as well as the flow of the first product and second product through the product dispensing unit 100. The directional flow of the first product is identified by the solid arrow A and the directional flow of the second product is identified by the dotted arrow B included in FIG. 3.

As described above, the engagement member 206 provides the primary frictional connection to secure the inner tube 202 to the outer tube 102. More specifically, the engagement shelf 208 and the engagement ribs 210 create frictional connection with the inner surface of the nozzle 106. As illustrated in FIG. 3, the inner surface of the nozzle 106 comprises receiving grooves 110 and a receiving shelf 112. The receiving grooves 110 are configured to couple with the engagement ribs 210 to facilitate in creating a frictional connection between the engagement member 206 and the nozzle 106. The receiving shelf 112 is configured to couple with the engagement shelf 208 to facilitate in creating a frictional connection between the engagement member and the nozzle 106. As illustrated in FIGS. 2A and 2B, the engagement shelf 208 and engagement ribs 110 substantially surround the engagement member 206 and, as a result, provide a substantially surrounding frictional connection between the engagement member 206 and the nozzle 106. The substantially surrounding frictional connection between the engagement member 206 and the nozzle 106 may firmly secure the inner tube 202 to the outer tube 102 and reduces the likelihood of the inner tube 202 decoupling from the outer tube 102. While not shown in the embodiment of the present invention illustrated in FIG. 3, in an embodiment of the present invention wherein the inner tube 202 comprises support structures 218, the support structures 218 may provide additional contact between the inner tube 202 and the outer tube 102 aids in maintaining the tubes in a concentric orientation during assembly, filling and use.

In addition to securing the engagement member 206 to the nozzle 106, the engagement member 206 is configured to facilitate the flow of the first product and the second product through the product dispensing unit 100. As described above, the outer tube cavity 104 is configured to house a first product. In response to the application of pressure to the product dispensing unit 100, the first product may flow from the outer tube cavity 104 through the port 212 into the outer channel 216 and exit the product dispensing unit 100 at dispensing site 108. As illustrated in FIG. 3, the port 212, located on the engagement member 206, facilities fluid communication between the outer tube cavity 104 and the outer channel 216, as identified by solid arrow A. As a result, the first product may flow through the engagement member 206 at the port 212. Therefore, according to an embodiment of the present invention, the port 212 allows the first product to flow through the engagement member 206, while at the same time, the engagement member 206 may secure the inner tube 202 to the outer tube 102 through the frictional connection between the engagement ribs 210 with the receiving grooves 110.

The embodiment of the present invention in FIG. 3 also illustrates the fluid communication between the inner tube cavity 204 and the inner channel 218. As a result of this fluid communication, the second product location in the inner tube cavity 204 may flow from the inner tube cavity 204 through the inner channel 218 and be dispensed at the dispensing site 108, as identified by dotted arrow B. As a result of the nested configuration between the outer tube 102 and the inner tube 202, application of pressure to the outer tube 102 may result in a portion of the applied pressure being transferred to the inner tube 202. The transferred pressure may result in forcing the second product from the inner tube cavity 204 through the inner channel 218 and dispensing of the first product and the second product simultaneously.

As illustrated in FIG. 3, the engagement member 206 substantially surrounds the dispensing conduit 214. As a result of this configuration, the outer channel 216 substantially surrounds the inner channel 218. The orientation of the outer channel 216 substantially surrounding the inner channel 218 facilitates simultaneously dispensing the first product and the second product wherein the first product may surround the second product when the products exit the nozzle 106 at the dispensing site 108.

Given that the application of pressure to the outer tube 102 may result in simultaneously dispensing the first product and the second product, alternative embodiments of the present invention may allow from different proportions the first product and the second product to be dispensed. For example, in an embodiment wherein the amount in the first product dispensed should greater than the amount of the second product, the diameter of the inner channel 218, as defined by the dispensing conduit 214, may be decreased while the diameter of the outer channel 216 may be increased. The change in diameters may result in an increased flow of the first product with respect to the second product upon the application of pressure to the product dispensing unit 100, thereby dispensing more of the first product in proportion to the second product. In a further embodiment of the present invention wherein the amount in the first product dispensed should greater than the amount of the second product dispensed, additional ports 212 may be including on the engagement member 206. As a result of the additional ports 212, the flow of the first product through the engagement member 206 thereby increasing the amount of the first product dispensed compared to the amount of the second produced dispensed. Additional embodiments of the present invention may be configured to affect the portions of first product and second product dispensed. According to embodiments of the present invention, the ratio between the diameters of the inner tube 202 and outer tube 102 may be established in order to control the ratio between the amount of the first product and the second product dispensed by apparatus 100.

According to certain embodiments of the present the first tube 102 and the second tube 202 may be constructed from the same material or more different materials. The nature of the products housed in the product dispensing unit 100 may dictate the material from which the first tube 102 or second tube 202 is constructed. For example, the erosive nature of hair dye may require a tube to be comprised of aluminum or other erosion-resistant material. Other materials that may be used to construct the inner tube or outer tube may include, but is not limited to, aluminum laminate or plastic.

It is to be understood that the exemplary embodiments described herein are merely illustrative of the present invention and that many variations of the above-described embodiments may be appreciated by one skilled in the art without departure from the scope of the invention. It is intended that all such variations be included within the scope of the following claims and their equivalents.

What is claimed is:

1. An apparatus for dispensing a first product and a second product, comprising:
an outer tube comprising:
an outer tube cavity, and
a nozzle comprising a dispensing site; and
an inner tube at least partially surrounded by the outer tube cavity, the inner tube comprising:
an inner tube cavity, and
an inner tube first end comprising:
a dispensing conduit comprising an inner channel providing a fluid path between the inner tube cavity and an opening in communication with the dispensing site, and
an engagement member configured to define an outer channel providing a fluid path between the outer tube cavity and the dispensing site, wherein the engagement member is engaged with the nozzle to secure the inner tube to the outer tube.

2. The apparatus of claim 1, wherein the engagement member comprises one or more ribs configured to engage with the nozzle.

3. The apparatus of claim 1, wherein a frictional connection between the engagement member and the nozzle secures the inner tube to the outer tube.

4. The apparatus of claim 1, wherein an engagement between the engagement member and the nozzle creates a seal between the inner tube and the outer tube.

5. The apparatus of claim 1, configured to facilitate the flow of a first product housed in the outer tube cavity from the outer tube cavity through at least one of the one or more ports into the outer channel for dispensing at the dispensing site.

6. The apparatus of claim 5, configured to facilitate the flow of a second product housed in the inner tube cavity from the inner tube cavity into the outer channel for dispensing at the dispensing site.

7. The apparatus of claim 6, wherein the first product substantially surrounds the second product when the first product and second product exit the apparatus.

8. The apparatus of claim 1, wherein the outer tube and the inner tube are constructed of different materials.
